(19) United States
(12) Patent Application Publication
(10) Pub. No.: US 2002/0194612 A1
(43) Pub. Date: Dec. 19, 2002

(54) Multimedia presentation

(76) Inventors: Jonas Lundberg, Lulea (SE); Anders Nohlgren, Lulea (SE)

Correspondence Address: NIXON & VANDERHYE P.C., 1100 North Glebe Road, 8th Floor, Arlington, VA, 22201, US

(21) Appl. No.: 10/141,354

(22) Filed: May 9, 2002

(30) Foreign Application Priority Data
May 11, 2001 (SE) 0101677-3

(51) Int. Cl. H04N 7/173; G06F 15/16

(52) U.S. Cl. 725/115; 725/105; 725/93; 709/219; 725/116

(57) ABSTRACT

A method for presentation of media objects of a multimedia presentation document (104) in a device (105) for presentation of such documents. The media objects are stored in storage means (102), which are remotely located from said device (105) and connected to a network infrastructure (103). The method comprises the steps of: providing said multimedia presentation document with metadata relating to properties of the media objects; processing said metadata in the presentation device (105); determining when to fetch each of said media objects from the storage means (102) to the presentation device (105) via the network infrastructure (103) based on said processing; fetching the media objects from the storage means (102) at the determined moments and presenting the fetched media objects in the presentation device (105). The invention also relates to a multimedia presentation system, a multimedia presentation document, a computer program product and a multimedia presentation device.

### FIELD OF THE INVENTION

The present invention relates broadly to the area of multimedia presentation, and more particularly to presentation of media objects of a multimedia document in a device for presentation of such documents.

### DESCRIPTION OF RELATED ART

Multimedia presentations in general are composed of a plurality of media objects of different kinds, such as for instance still images, audio, video, text, etc. The media objects can be classified into two categories, static and dynamic media objects. Dynamic media objects, such as audio and video, are naturally associated with a duration time, in contrast to static media objects, such as still images and text. A multimedia presentation document defines the mutual temporal relationship between the media objects of the presentation, i.e. when presentation of each media object is to be performed. The presentation document may also define the mutual spatial relationship between the objects, i.e. the visual layout, but of course this only applies to media objects which are possible to display visually.

When the media objects are stored in storage means remotely located from a device which is to perform presentation thereof, the media objects have to be transmitted from the storage means to the presentation device in time for the presentation. Presentation devices normally fetch the media objects as soon as it becomes possible or at intervals. However, the former approach is associated with large data buffering in the presentation device, which is disadvantageous, especially in small mobile presentation devices, in which memory is precious. Fetching the media objects at intervals leads to interruptions in the presentation, when the media objects do not arrive in time. The cause thereof may be for instance congestion in the network infrastructure interconnecting the storage means and the presentation device or that the storage means do not respond to requests for fetching media objects.

### SUMMARY OF THE INVENTION

The object of the present invention is therefore to provide presentation of media objects of a multimedia presentation document, which is improved as regards the fetching of the media objects from the remotely located storage means to the presentation device.

According to one aspect of the invention, this object is achieved by a method for presentation of media objects of a multimedia presentation document in a device for presentation of such documents, said media objects being stored in storage means, which are remotely located from said device and connected to a network infrastructure, the method comprising the steps of:

providing said multimedia presentation document with metadata relating to properties of the media objects;

processing said metadata in the presentation device;

determining when to fetch each of said media objects from the storage means to the presentation device via the network infrastructure based on said processing;

fetching the media objects from the storage means at the determined moments and presenting the fetched media objects in the presentation device. The information obtained from the processing of the metadata allows for improved scheduling of when to fetch each media object to the presentation device. This implicates decreased buffer requirements in the presentation device and interruptions in the multimedia presentations are avoided to a great extent. The decreased buffer requirements enable caching of more media objects in the presentation device. The improved scheduling of when to fetch the media objects and the possibility to use a larger portion of the storage means in the presentation device for caching media objects makes it easier for the presentation device to keep the presentation of the media objects synchronised, i.e. to maintain the mutual temporal relationship between the objects as specified by the presentation document.

According to a preferred embodiment of the present invention presentation of said media objects in the presentation device is synchronised based on said processing. Thus, the processing of the metadata gives the presentation device information concerning the media objects, which enables the device to synchronise the presentation of the media objects even if some media objects are missing or do not arrive in time for presentation thereof.

According to a further aspect of the present invention, this object is achieved by a multimedia presentation system, comprising a multimedia presentation document including references to media objects, a device for presentation of such documents, storage means for said media objects remotely located from said device and connected to a network infrastructure, in which system

the multimedia presentation document comprises metadata relating to properties of said media objects,

the presentation device is arranged to process said metadata and to determine when to fetch each of said media objects from said storage means to the presentation device via said network infrastructure based on said processing.

According to another aspect of the present invention, this object is achieved by providing a multimedia presentation document, for use with a computer program product in a multimedia presentation device, said document including references to media objects stored in storage means, which are remotely located from said device and connected to a network infrastructure, comprising

metadata relating to properties of said media objects to be used for determining when to fetch each of said media objects from said storage means to the presentation device via said network infrastructure.

According to still another aspect of the present invention, this object is achieved by a computer program product, directly loadable into the internal memory of a multimedia presentation device for presentation of a document according to the above paragraph, said product comprising software for making the presentation device

determine when to fetch each of said media objects from said storage means to the presentation device via said network infrastructure based on said metadata,

when said product is run on the presentation device.

According to a further aspect of the present invention, this object is achieved by a multimedia presentation device for presentation of a document according to the penultimate paragraph above, having recorded thereon a computer program product, where the product is to make the device

determine when to fetch each of said media objects from said storage means to the presentation device via said network infrastructure based on said metadata.

Further advantages as well as advantageous features of the invention will appear from the following description and dependent claims.

### BRIEF DESCRIPTION OF THE DRAWINGS

With reference to the appended drawings, below follows a specific description of preferred embodiments of the invention cited as examples.

FIG. 1 shows a multimedia presentation system according to a first embodiment of the invention,

FIG. 2 shows a multimedia presentation system according to a second embodiment of the invention,

FIG. 3 illustrates, by means of a flow diagram, a method for presentation of media objects according to the invention, and

FIG. 4 illustrates, by means of a flow diagram, another method for presentation of media objects according to the invention.

### DETAILED DESCRIPTION OF PREFERRED EMBODIMENTS OF THE INVENTION

FIG. 1 illustrates schematically a multimedia presentation system according to a first embodiment of the present invention. A network infrastructure 103 is included in the system. The network infrastructure 103 may be of any suitable kind, but preferably it comprises a Transmission Control Protocol/Internet Protocol (TCP/IP) network such as the Internet. As shown in FIG. 1, one or more media servers 101 are connected to the network infrastructure 103. Each server 101 may comprise, for example, one or more processors, long-term and short-term storage means, communication means, application programs etc., for the purpose of providing media content. The media content is provided as a plurality of separate media objects, in the form of data files representing for instance audio clips, video clips, still images and text. The media objects are stored in storage means 102 on servers 101 and thus accessible via the network infrastructure 103.

Furthermore, the system comprises a multimedia presentation document, schematically indicated at 104, which includes references to a plurality of media objects and defines the presentation. The document 104 may describe the mutual temporal and spatial relationship between the media objects as well as how different media objects are to be presented, which input/output devices to use for presentation thereof etc. In other words, the document specifies the presentation in terms of when, where and how to present the media objects of the presentation document. The media objects are included in a presentation document by means of a reference thereto, for instance via a uniform resource locator (URL) identifying the location of the storage means in which the respective media objects are stored. The identification may be achieved by the URL comprising for instance an Internet Protocol (IP) address or a domain name of a server 101 and the path name to a data file on that server. The presentation document may for instance be implemented by means of the Synchronised Multimedia Integration Language (SMIL) designed by the World Wide Web Consortium (W3C). SMIL is a language similar to HTML and is well suited for authoring multimedia presentations.

Indicated at 105 is a presentation device included in the system. The device 105 may be any mobile or stationary unit capable of performing presentation of multimedia presentation documents as discussed above and may comprise one or more processors, short-term and long-term storage means, communication means, Input/Output devices and suitable application programs, all of which are known in the art and which therefore not will be explained further. According to a preferred embodiment of the invention, the presentation device 105 is a wireless mobile telephone.

In FIG. 1 the presentation document 104 is schematically shown to be located in the presentation device 105, for instance by being loaded into storage means in the device 105. Performing presentation of the multimedia presentation document 104 is achieved by displaying and executing playback of the media objects, included by reference in the document, according to the mutual relationship between the objects as specified by the document 104. Thus, the presentation device 105 may be considered as a “media player”. However, since the media objects are remotely located from the presentation device, for instance stored in storage means 102 on servers 101 as illustrated in FIG. 1, they have to be fetched to the device 105 for presentation thereof. The media objects may for instance be communicated to the presentation device 105 by means of streaming, i.e. transmission of the data representing the media objects as a continuous stream. Streaming is advantageous in that it enables presentation of a media object to start before the entire file representing the media object has been transmitted to the presentation device 105. Another advantage with the use of streaming is that the entire file representing a media object does not have to be buffered in the presentation device 105, since the device 105 receives data at the same pace as data is used for presentation.

According to the present invention, the presentation document 104 comprises metadata relating to properties of the media objects. The term “metadata” as used in this specification is to be given a very broad meaning, relating to “data about data”, and in particular to data about media objects. Thus, this term is not to be construed as being limited to any similar term associated with any specific programming language. The metadata may comprise, but is not restricted to, data relating to file size of the media objects, duration time of the playback of the dynamic media objects, the mutual priority of the media objects, and estimated response times for the servers 101 on which the storage means 102 for the media objects are located. The metadata is preferably implemented according to the Resource Description Format (RDF), the syntax of which preferably uses the extensible Markup Language (XML). The metadata may be implemented directly in the document 104, or may just as well be included in the document 104 by means of a reference thereto, for instance a URL to a file comprising the metadata.

The presentation device 105 is arranged to process the metadata and to determine when to fetch each media object from the storage means 102 based on the processing of the metadata. The device 105 preferably fetches the media objects by sending requests for the media objects to the servers 101, which responsive thereto communicate the media objects to the device 105 via the network infrastructure 103, for instance by means of streaming. By processing the metadata, the presentation device 105 obtains information about the media objects prior to communication with the storage means 102 in which they are stored. This enables the device 105 to calculate moments suitable for fetching media objects so that they arrive at the device 105 well in time for presentation thereof and thus interruptions in the presentation are prevented. This improved scheduling of when to fetch each media object to the presentation device implicates decreased buffer requirements in the presentation device 105 and, accordingly, a larger portion of the storage means in the device 105 may be used for caching media objects. Preferably, the media objects that are used most frequently in the presentation are placed in the cache of the presentation device. Thanks to the improved scheduling of when to fetch the media objects and the possibility to cache more media objects in the presentation device, synchronisation of the presentation of the media objects in the presentation device is improved. In other words, it is easier for the presentation device to maintain the mutual temporal relationship between the media objects during the presentation.

Another possible way of obtaining information about the media objects would be for the device 105 to send for instance file size requests to each server 101, but this leads to extra communication traffic and, accordingly, decreased bandwidth utilisation. Thus, the usage of metadata in the document 104 also provides for advantageous bandwidth utilisation.

According to a preferred embodiment of the present invention the presentation device 105 is arranged to synchronise presentation of the media objects based on the processing of the metadata. In addition to the improved synchronisation already obtained as described above, the device 105 is thus able to further synchronise the presentation of the media objects by utilising information about the media objects gained from the processing of the metadata. If some media objects are missing or arrive too late, which may occur for instance if a server 101 does not respond or due to congestion in the network 103, the presentation device may utilise for instance information relating to the duration time of the playback of the missing media objects to properly start and/or end presentation of other media objects as specified by the document 104.

Preferably, the device 105 utilises a suitable bandwidth estimation algorithm for estimating available bandwidth in the network 103 and calculates transmission times, i.e. the duration of transmission, from the storage means 102 to the device 105 based on the estimated bandwidth and the metadata, preferably data relating to file size of the media objects. This provides for further improved scheduling of when to fetch each media object and lowered buffering requirements in the device 105, which is advantageous. Using metadata relating to estimated response times for the servers 101 further improves the scheduling. The estimated response times may for instance be associated with Round Trip Times (RTT) for the servers involved.

Due to congestion in the network 103, the available bandwidth may not always be sufficient for transmission of all media objects of the presentation from the storage means 102 to the presentation device 105. If the bandwidth estimated as above is found to be insufficient, the device 105 preferably determines the mutual priority between the media objects based on the metadata and fetches only the media objects having the highest priority, i.e. fetching of objects having high priority is preferred over fetching of objects having low priority. Furthermore, the metadata relating to mutual priority between the media objects may also be used for deciding which media objects to fetch when available space in the storage means in the presentation device 105 does not allow fetching of all media objects.

The presentation document 104 is in the example in FIG. 1 schematically shown as being located in the presentation device 105, but this is of course not to be considered as limiting the present invention in any way.

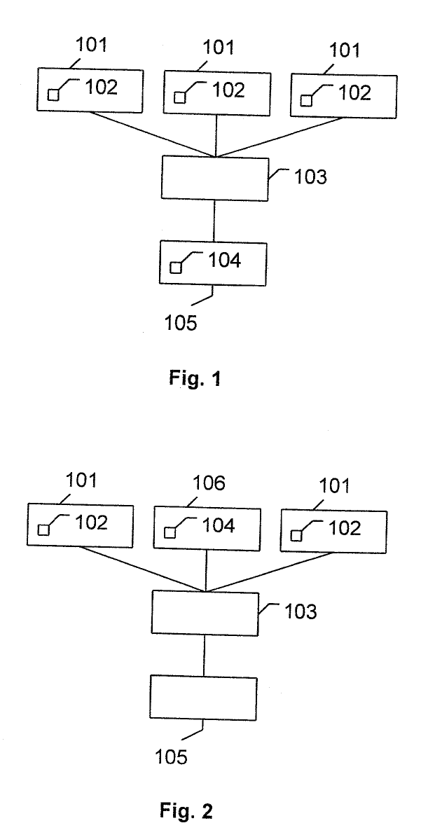

FIG. 2 shows a multimedia presentation system according to a second embodiment of the present invention. This system is substantially similar to the system shown in FIG. 1. However, in this system the multimedia document 104 is remotely located from the presentation device 105, namely on a server indicated at 106, which for instance may comprise components similar to those of the servers 101. The server 106 may also comprise storage means in which media objects of the document 104 are stored. In this embodiment the device 105 has to retrieve the document 104 from the server 106 before performing presentation of the document 104. It is pointed out that the device 105 may fetch the document 104 at any suitable time. Thus, the document 104 may be fetched just in time for presentation thereof or it may be fetched and stored in storage means in the device 105 until a future presentation thereof is to be performed. Apart from the differences mentioned above, this system works similarly to the system described with reference to FIG. 1.

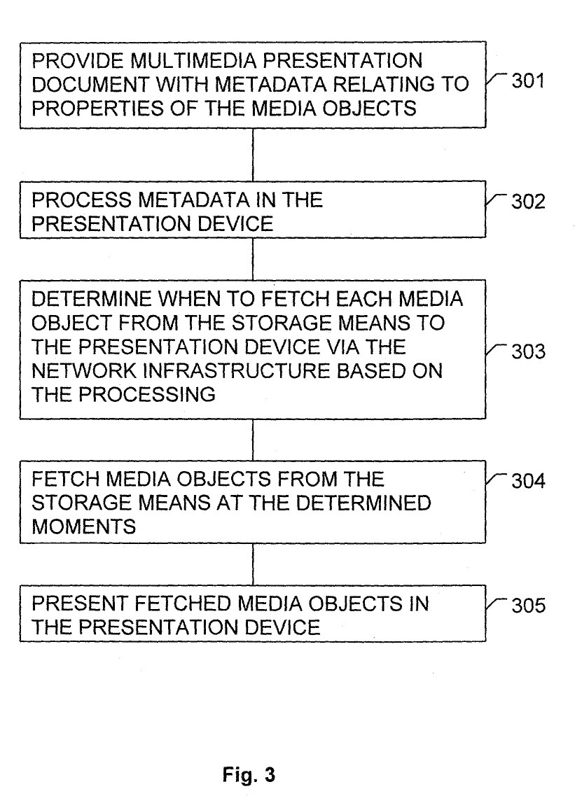

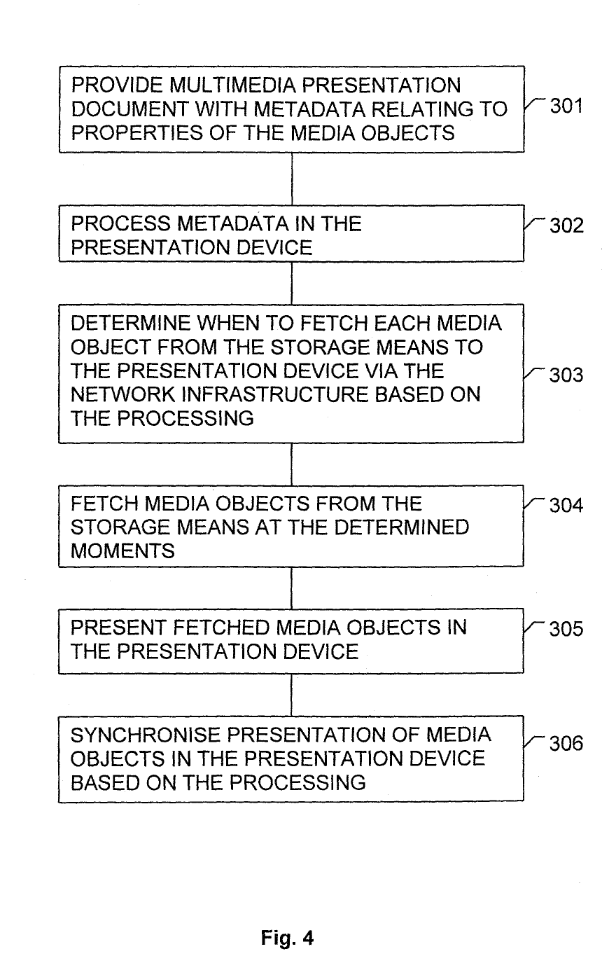

A method for presentation of media objects according to the invention is illustrated in FIG. 3 by means of a flow diagram. A first step 301 provides the multimedia presentation document with metadata relating to properties of the media objects. The metadata is processed in the presentation device in a following step 302. A subsequent step 303 determines when to fetch each of the media objects from the storage means to the presentation device via the network infrastructure based on said processing. A further step 304 fetches the media objects from the storage means at the determined moments. Finally, in a step 305, the fetched media objects are presented in the presentation device. Another method for presentation of media objects according to the invention is illustrated in FIG. 4 by means of a flow diagram. This method is similar to the one illustrated in FIG. 3, but this method also includes a step 306, in which presentation of the media objects in the presentation device is synchronised based on the processing.

The term “comprises/comprising” when used in this specification is taken to specify the presence of stated features, integers, steps or components but does not preclude the presence or addition of one or more other features, integers, steps, components or groups thereof.

The invention is of course not restricted to the embodiments described above, but many possibilities to modifications thereof may be envisaged by persons skilled in the art without departing from the scope of the invention as defined in the appended claims.

1. A method for presentation of media objects of a multimedia presentation document (104) in a device (105) for presentation of such documents, said media objects being stored in storage means (102), which are remotely located from said device and connected to a network infrastructure (103), said method being characterised by having the steps of:
providing said multimedia presentation document (104) with metadata relating to properties of the media objects;
processing said metadata in the presentation device (105);
determining when to fetch each of said media objects from the storage means (102) to the presentation device (105) via the network infrastructure (103) based on said processing;
fetching the media objects from the storage means (102) at the determined moments and presenting the fetched media objects in the presentation device (105).

2. A method according to claim 1, characterised in that presentation of said media objects in the presentation device (105) is synchronised based on said processing.

3. A method according to any of claims 1-2, characterised in that said metadata is provided with data relating to file size of the media objects.

4. A method according to claim 3, characterised in that available bandwidth in the network infrastructure (103) is estimated and that transmission times from the storage means (102) to the presentation device (105) are calculated based on the estimated bandwidth and said metadata.

5. A method according to claim 3 or 4, characterised in that available bandwidth in said network infrastructure (103) is estimated, that the mutual priority between the media objects is determined based on said metadata, and that only the media objects having the highest priority are fetched when the estimated available bandwidth not is sufficient for fetching all media objects.

6. A method according to any of claims 1-5, wherein said media objects comprise dynamic media objects, characterised in that said metadata is provided with data relating to duration time of the playback of the dynamic media objects.

7. A method according to any of claims 1-6, characterised in that said metadata is provided with data relating to the mutual priority of the media objects.

8. A method according to any of claims 1-7, wherein said storage means (102) for said media objects are located on one or more servers (101), characterised in that said metadata is provided with data relating to estimated response times for said servers (101).

9. A method according to any of the preceding claims, characterised in that the multimedia presentation document (104) is stored in a storage means remotely located from the presentation device (105) and fetched from said storage means to the presentation device (105).

10. A multimedia presentation system, comprising a multimedia presentation document (104) including references to media objects, a device (105) for presentation of such documents, storage means (102) for said media objects remotely located from said device (105) and connected to a network infrastructure (103), said system being characterised in that
the multimedia presentation document (104) comprises metadata relating to properties of said media objects,
the presentation device (105) is arranged to process said metadata and to determine when to fetch each of said media objects from said storage means (102) to the presentation device (105) via said network infrastructure (103) based on said processing.

11. A system according to claim 10, characterised in that the presentation device (105) is arranged to synchronise presentation of said media objects based on said processing.

12. A system according to claim 10 or 11, characterised in that the presentation device (105) is arranged to estimate available bandwidth in said network infrastructure (103) and to calculate transmission times from said storage means (102) to the presentation device (105) based on said estimated bandwidth and said metadata.

13. A system according to any of claims 10-12, characterised in that the presentation device (105) is arranged to estimate available bandwidth in said network infrastructure (103), determine the mutual priority between the media objects based on said metadata, and only fetch the media objects having the highest priority when the estimated available bandwidth not is sufficient for fetching all media objects.

14. A system according to any of claims 10-13, characterised in that said metadata includes data relating to file size of said media objects.

15. A system according to any of claims 10-14, wherein said media objects comprise dynamic media objects, characterised in that said metadata includes data relating to duration time of said dynamic media objects.

16. A system according to any of claims 10-15, characterised in that said metadata includes data relating to the mutual priority of said media objects.

17. A system according to any of claims 10-16, wherein said storage means (102) for said media objects are located on one or more servers (101), characterised in that said metadata includes data relating to estimated response times for said servers (101).

18. A system according to any of claims 10-17, characterised in that the multimedia presentation document (104) is stored in a storage means remotely located from the presentation device (105) and that the presentation device is arranged to fetch the presentation document (104) from said storage means.

19. A system according to any of claims 10-18, characterised in that the multimedia presentation device (105) is a wireless mobile telephone.

20. A multimedia presentation document (104), for use with a computer program product in a multimedia presentation device (105), said document including references to media objects stored in storage means (102), which are remotely located from said device and connected to a network infrastructure (103), said document being characterised in that it comprises
metadata relating to properties of said media objects to be used for determining when to fetch each of said media objects from said storage means (102) to the presentation device (105) via said network infrastructure (103).

21. A document according to claim 20, characterised in that it comprises
metadata relating to properties of said media objects to be used for synchronising presentation of said media objects in the presentation device (105).

22. A document according to claim 20 or 21, characterised in that said metadata includes data relating to file size of said media objects.

23. A document according to any of claims 20-22, wherein said media objects comprise dynamic media objects, characterised in that said metadata includes data relating to duration time of the playback of said dynamic media objects.

24. A document according to any of claims 20-23, characterised in that said metadata includes data relating to the mutual priority of said media objects.

25. A document according to any of claims 20-24, wherein said storage means (102) for said media objects are located on one or more servers (101), characterised in that said metadata includes data relating to estimated response times for said servers (101).

26. A computer program product, directly loadable into the internal memory of a multimedia presentation device (105) for presentation of a document (104) according to any of claims 20-25, said product comprising software for making the presentation device
determine when to fetch each of said media objects from said storage means (102) to the presentation device (105) via said network infrastructure (103) based on said metadata,
when said product is run on the presentation device (105).

27. A product according to claim 26, further comprising software for making the presentation device (105)
synchronise presentation of said media objects based on said metadata,
when said product is run on the presentation device (105).

28. A multimedia presentation device (105) for presentation of a document (104) according to any of claims 20-25, having recorded thereon a computer program product, where the product is to make the device
determine when to fetch each of said media objects from said storage means (102) to the presentation device (105) via said network infrastructure (103) based on said metadata.

29. A device (105) according to claim 28, where the product further is to make the device
synchronise presentation of said media objects based on said metadata.

30. A device (105) according to claim 28 or 29, characterised in that it is a wireless mobile telephone.
